(19) United States
(12) Patent Application Publication
(10) Pub. No.: US 2003/0052052 A1
(43) Pub. Date: Mar. 20, 2003

(54) Integrated fuel filter and calibration tube for a fuel injector

(75) Inventors: Andrew J. Boast, Fontana, WI (US); Vanessa Price, Geneva, IL (US)

Correspondence Address: BRINKS HOFER GILSON & LIONE, P.O. BOX 10395, CHICAGO, IL, 60611, US

(73) Assignee: Filtertek Inc.

(21) Appl. No.: 10/251,704

(22) Filed: Sep. 19, 2002

Related U.S. Application Data
(60) Provisional application No. 60/323,750, filed on Sep. 19, 2001.

(51) Int. Cl. B01D 35/02

(52) U.S. Cl. 210/429; 210/497.01; 210/499; 210/432

(57) ABSTRACT

An integrated fuel filter and calibration tube for a fuel injector is preferably made from a filtration element comprising filtration media insert-molded into a thermoplastic frame member; and a metal calibration tube rigidly attached to the filtration element. The calibration tube is sized so as to fit inside of a fuel injector flow channel.

### REFERENCE TO RELATED APPLICATION

The present application claims the benefit of the filing date under 35 U.S.C. § 119(e) of Provisional U.S. Patent Application Serial No. 60/323,750, filed Sep. 19, 2001, which is hereby incorporated by reference in its entirety.

### BACKGROUND OF THE INVENTION

The present invention relates to filters for fuel injectors, and particularly to such fuel filters integrated with a calibration tube.

A fuel injector is used to inject fuel into a cylinder of an internal combustion engine. Typical a fuel filter is included inside the flow channel within the fuel injector to prevent any contaminants in the fuel from interfering with the operation of the fuel injector orifice. An example of such a filter is disclosed in U.S. Pat. No. 4,608,166, which is hereby incorporated by reference. This filter, shown in FIGS. 1-3 herein, was itself an improvement over earlier filters in that it includes a metal collar 26 that allowed the filter 10 to be press fit into the fuel injector flow channel and to stay in place as the fuel injector heated and expanded with use. The metal collar 26 was unique in that its leading edge 22 was embedded in thermoplastic material used to construct the filter, so that as the filter was press fit into place, a smooth rounded corner 24 contacted the internal wall of the flow channel. This prevented any shearing of particles from the wall of the flow channel, generating debris that would have been downstream of the filter.

While this was a significant improvement over the prior art, there has still been a potential source of particles with the use of such filters. Inside of the flow channel there is also a spring and a calibration tube. These are used to adjust the flow rate of fuel injected by the fuel injector. Often the filter element rested on the proximal end of the calibration tube. As a result, there is the potential for abrasion between the calibration tube and the filter, resulting in debris downstream of the filter that can clog the fuel injector or otherwise adversely affect engine performance.

There would be a great benefit if this source of potential particles could be eliminated. Also, it would be a benefit if the number of components used to construct a fuel injector were reduced, while maintaining a sufficient filtration capacity surface area.

### SUMMARY OF THE INVENTION

An integrated fuel filter and calibration tube has been invented which eliminates the potential for release of particles from the filter element by abrasion with the calibration tube. In preferred embodiments the filter is contained within the calibration tube, yet still has at least 60 mm² of effective filtration surface area.

In a first aspect, the invention is an integrated fuel filter and calibration tube for a fuel injector comprising a filtration element made from filtration media insert-molded into a thermoplastic frame member; and a calibration tube rigidly attached to the filtration element, the calibration tube being sized so as to fit inside of a fuel injector flow channel.

In a second aspect, the invention is an integrated fuel filter and calibration tube for a fuel injector comprising an elongated outside metal housing having a body with an inside diameter and an outside diameter, a neck at the distal end of the housing smaller in outside diameter than the outside diameter of the body and a shoulder at the proximal end of the housing larger in inside diameter than the inside diameter of the body; and an injection-molded filter element inside the housing, the filter element comprising filtration media insert-molded into a frame, the frame comprising a proximal end having an outside diameter in between the inside diameters of the housing shoulder and the housing body, a distal end and a plurality of rib members joining the proximal end to the distal end, the frame holding the filtration media in a generally cylindrical shape.

In a third aspect, the invention is a combination of a fuel injector and an integrated fuel filter and calibration tube comprising a fuel injector having a fuel flow channel therethrough and a spring inside the flow channel; and an integrated fuel filter and calibration tube inside the flow channel, the calibration tube contacting the spring, the fuel filter comprising a thermoplastic frame attached to the calibration tube, the frame having a proximal end, a distal end and at least one rib connecting the ends, the frame supporting filtration media to provide filtration of all fuel flowing through the fuel flow channel.

The integrated fuel filter and calibration tube may be inserted into a fuel injector as a unit, thus eliminating the possibility of particles being generated from abrasion between the filter and the calibration tube, as well as reducing the number of individual parts needed for the assembly of the fuel injector. The preferred embodiment includes a filter element that is easy to manufacture and assemble.

These and other advantages, as well as the invention itself, will be best understood in view of the attached drawings, a brief description of which follows:

### BRIEF DESCRIPTION OF THE DRAWINGS

FIGS. 1-3 are perspective and cross-sectional views of a prior art fuel injector filter.

FIG. 4 is a cross-sectional view of a combination of a fuel injector and an integrated fuel filter and calibration tube of a first embodiment of the present invention.

FIG. 5 is an end view of the integrated fuel filter and calibration tube taken along line 5-5 of FIG. 4.

FIG. 6 is a cross-sectional view of the calibration tube used in the integrated fuel filter and calibration tube of FIG. 5.

FIGS. 7 and 8 are cross-sectional views taken along lines 7-7 and 8-8, respectively, of FIG. 5.

FIG. 9 is a side view of the filter element used in the integrated fuel filter and calibration tube of FIGS. 4-5.

FIG. 10 is a cross-sectional view taken along line 10-10 of FIG. 9.

FIG. 11 is an end view taken along line 11-11 of FIG. 9.

FIGS. 12, 13 and 14 are cross-sectional views taken along lines 12-12, 13-13 and 14-14, respectively, of FIGS. 10 and 11.

FIG. 15 is a side elevational view of a fuel filter used in making a second embodiment of the integrated fuel filter and calibration tube of the present invention.

FIG. 16 is a cross-sectional view of the calibration tube used in the second embodiment of the invention.

FIG. 17 is an end view taken along line 17-17 of FIG. 15.

FIG. 18 is a cross-sectional view taken along line 18-18 of FIG. 15.

FIGS. 19 and 20 are cross-sectional views of the integrated fuel filter and calibration tube of FIGS. 15 and 16.

FIG. 21 is a side elevational view of a fuel filter used in a third embodiment of an integrated fuel filter and calibration tube of the present invention.

FIGS. 22 and 23 are end views taken along lines 22-22 and 23-23, respectively, of FIG. 21.

FIGS. 24, 25 and 26 are cross-sectional views taken along lines 24-24, 25-25 and 26-26, respectively, of FIGS. 21, 24 and 23.

FIG. 27 is a cross-sectional view of a calibration tube used with the fuel filter of FIG. 21 in making the third embodiment of the invention.

FIG. 28 is a cross-sectional view of the integrated fuel filter and calibration tube of FIGS. 21 and 27.

FIG. 29 is a side elevational view of a fuel filter used in a fourth embodiment of an integrated fuel filter and calibration tube of the present invention.

FIGS. 30 and 31 are end views taken along lines 30-30 and 31-31, respectively, of FIG. 29.

FIGS. 32, 33 and 34 are cross-sectional views taken along lines 32-32, 33-33 and 34-34, respectively, of FIGS. 29, 32 and 31.

FIG. 35 is a side elevational view of a calibration tube used with the fuel filter of FIG. 29 in making the fourth embodiment of the invention.

FIGS. 36 and 37 are cross-sectional views of the integrated fuel filter and calibration tube of FIGS. 29 and 35.

FIG. 38 is a side elevational view of a fifth embodiment of an integrated fuel filter and calibration tube of the present invention.

FIG. 39 is a side elevational view of a filter element used to make an integrated fuel filter and calibration tube of a sixth embodiment of the present invention.

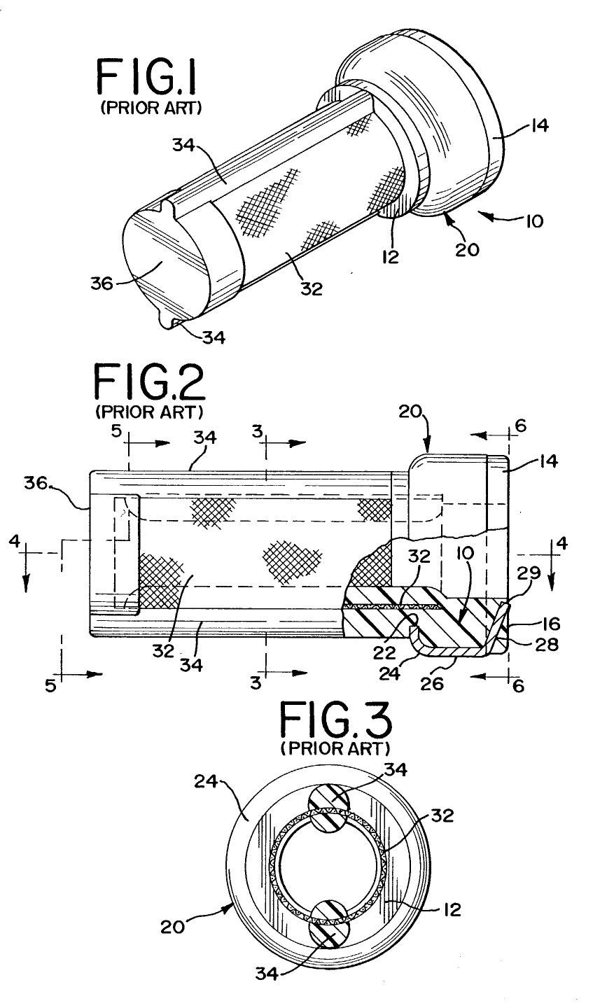

### DETAILED DESCRIPTION OF THE DRAWINGS AND PREFERRED EMBODIMENTS OF THE INVENTION

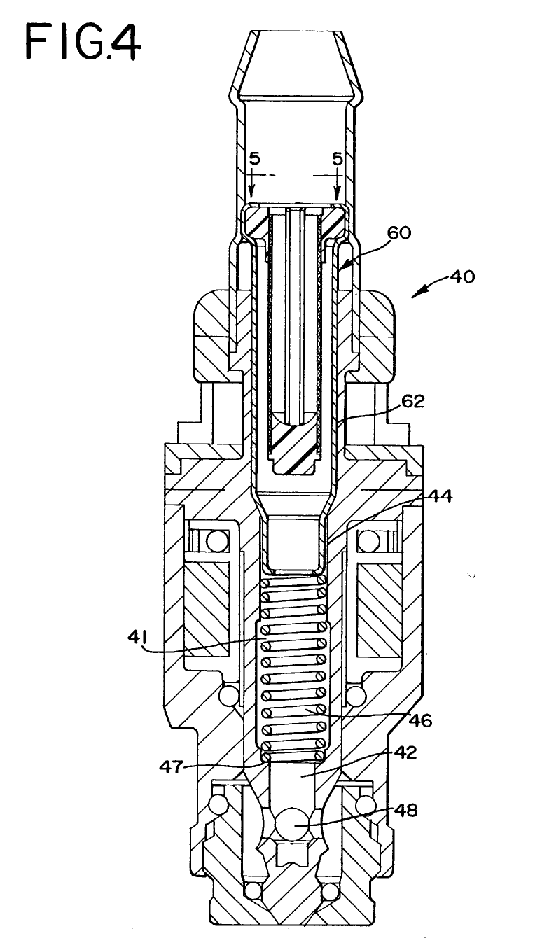

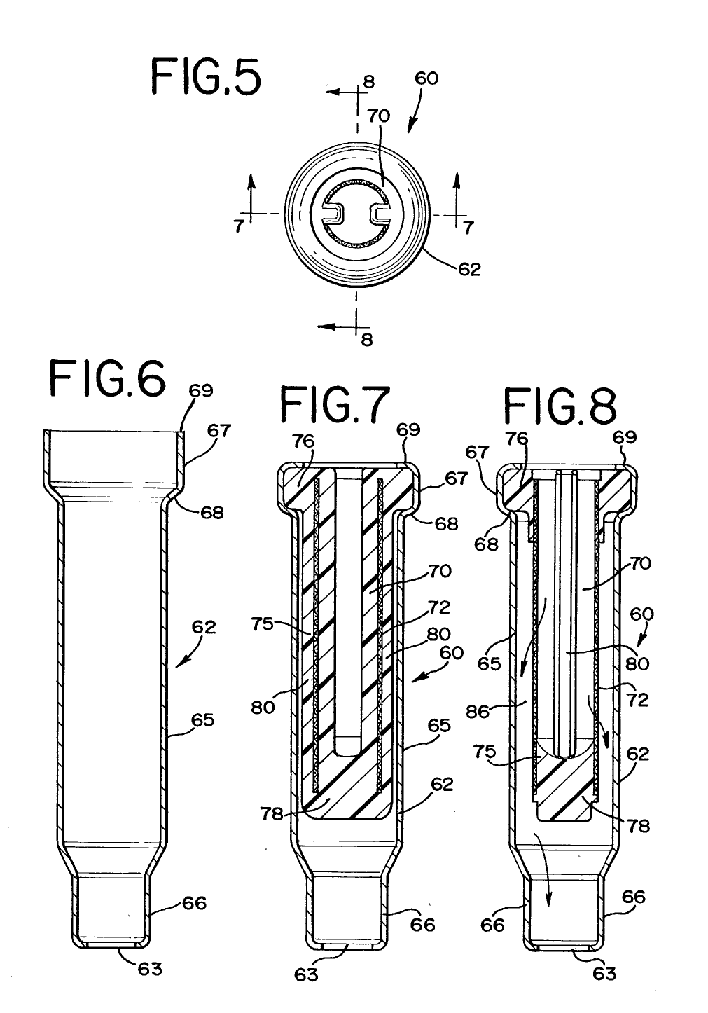

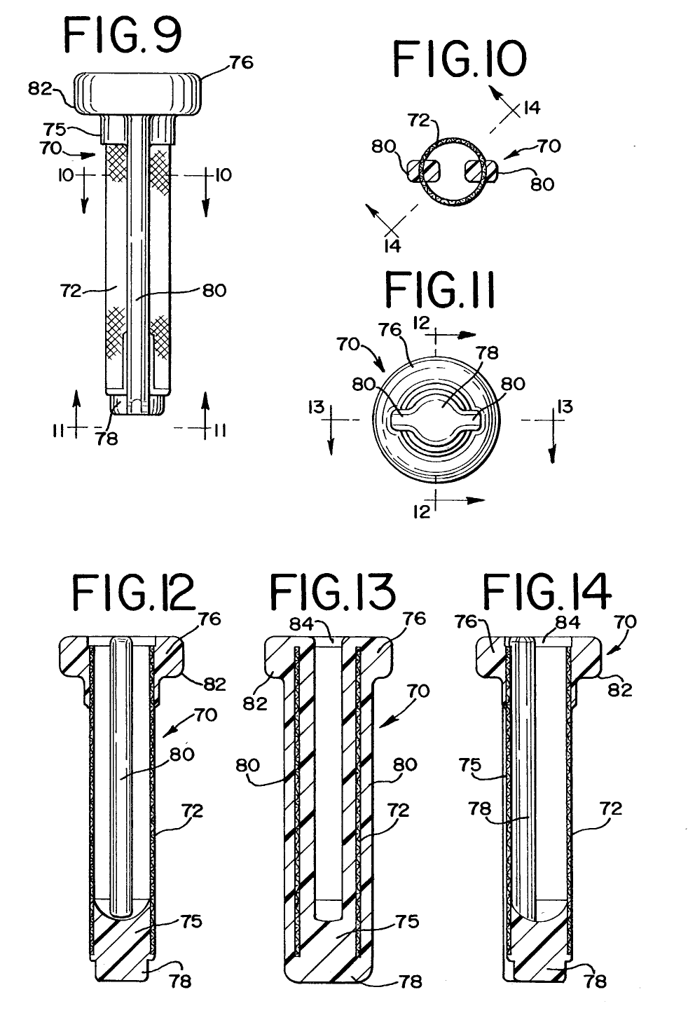

The preferred embodiment of an integrated fuel filter and calibration tube 60 of the present invention is shown in combination with other components of a fuel injector 40 in FIG. 4. The integrated fuel filter and calibration tube 60 is shown in FIGS. 5, 7 and 8. Its components include a housing or calibration tube 62, best seen in FIG. 6, and a filter element 70 best seen if FIGS. 9-14.

The fuel injector 40 has a fuel flow channel 41 therethrough. The flow channel 41 has a lower portion 42 and an upper portion 44. A spring 46 is inside the flow channel 41. The internal diameter of the lower portion 42 is less than the internal diameter of the upper portion 44. The spring 46 rests on the shoulder 47 formed in the flow channel where the internal diameter changes. Other components of the fuel injector 40, such as ball 48, are conventional and therefore not further described. The upper portion 44 of the flow channel may have different internal diameters, as shown in FIG. 4, used to accommodate the integrated fuel filter and calibration tube 60, which also fits within the flow channel 41. The calibration tube 62 contacts the spring 46 and is sized so as to fit inside the flow channel 41.

As best seen in FIGS. 5-14, the integrated fuel filter and calibration tube 60 has two major components, the calibration tube or housing 62 and the filter element 70. The calibration tube 62 is preferably an elongated, drawn, stainless steel tube. Although other metals could be used, stainless steel has the advantage of not reacting with components used in the wide variety of fuels that may be fed through injector 40. The metal tube 62 is rigidly attached to the filtration element 70 after both pieces are first produced independently. The tube 62 forms an elongated outside housing for the preferred filter element 70. The tube 62 has a main body portion 65, a neck 66 at the distal end of the housing and a shoulder 67 at the proximal end of the housing. The neck 66 is smaller in outside diameter than the outside diameter of the body 65. The shoulder 67 has an internal diameter larger than that of the body 65. This shoulder 67 is sized on its outside diameter so that the combined fuel filter and calibration tube 60 may be press fit into the upper portion of the fuel flow channel 41. The juncture 68 of the housing between the body 65 and the shoulder 67 forms an internal ledge. As shown in FIGS. 7 and 8, the proximal edge 69 of the housing shoulder 67 is crimped over, preferably by rolling process, to hold a proximal end 76 of the filter element 70 against the ledge 68.

The fuel filter portion of the preferred integrated fuel filter and calibration tube 60 is preferably an injection-molded filter element inside the housing 62 made up of filtration media 72 insert molded into a thermoplastic frame member 75. The media 72 is preferably a woven nylon screen, held in a generally cylindrical shape by the frame member 75.

The frame member 75 comprises a proximal end 76, a distal end 78 and at least one, and preferably two, rib members 80 joining the proximal end 76 to the distal 78. The two ribs 80 are spaced at 180° from each other around the perimeter of the filtration media cylinder. The proximal end 76 includes a shoulder 82 and a fuel inlet opening 84 along its axial center. The shoulder 82 is used to secure the filtration element 70 to the calibration tube 62. In the embodiment shown in FIGS. 4-14, the outside diameter of the shoulder 82 of the proximal end of the filtration element is just smaller than the inside diameter of the shoulder section 67 of the calibration tube 62 but larger than the inside diameter of the housing body 65. Also, in the first embodiment, the filtration element 70 is totally contained within the calibration tube 62. However, even fitting inside this small area, the preferred design still is made with an effective filtration surface area of at least 60 mm². The flow path of fuel through the filtration element is radially outward, as fuel enters through inlet opening 84 and is filtered as it passes outwardly through the filtration media 72 as shown by flow arrows in FIG. 8. The fuel then passes into the space 86 between the filter element 70 and the calibration tube 62, and flows out the opening 63 at the distal end of the calibration tube 62. The preferred frame material is a 35% glass filled 6-12 nylon. The preferred media 72 is a 30 micron woven nylon screen.

By replacing the separate fuel filter and calibration tube, the wear surface between the calibration tube and filter is eliminated. The preferred parts are easily manipulated by automatic handling equipment. The stainless steel has minimal, if any, chemical and electrolyte reaction at the interfaces between the fuel filter and other components of the fuel injector.

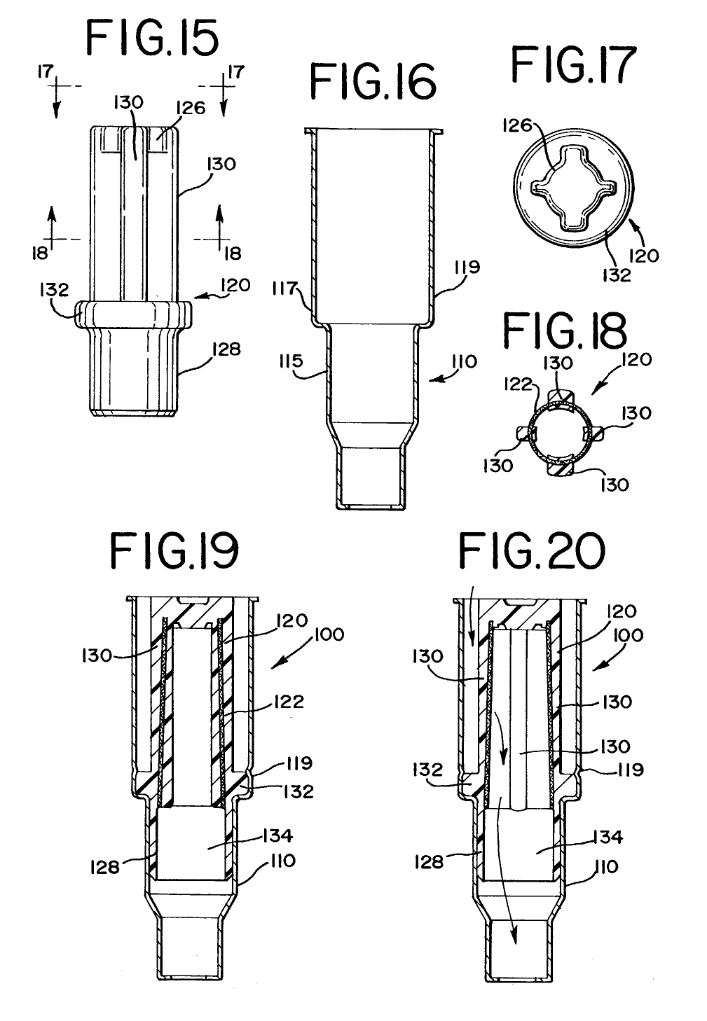

Other embodiments of the invention have many of the same benefits. The embodiment of FIGS. 15-20 is also an integrated fuel filter and calibration tube 100. Again, the tube 110 is preferably made from stainless steel, and has a body portion 115 and an upper section 117. In this embodiment, the filter element 120 is designed with a flow path of fuel through the filtration element radially inward. Fuel thus enters through media 122 held open by ribs 130 connecting the proximal end 126 and the base 128 of the filter frame. The flow then passes out an opening 134 in the base 128 of the filter element 120. The base 128 includes a shoulder 132 that is secured inside the upper section 117 of the calibration tube 110. The two pieces are held together by crimping in a center section 119 of the tube 110 to clamp over the shoulder 132 of the frame of the filter element 120 (FIGS. 19 and 20).

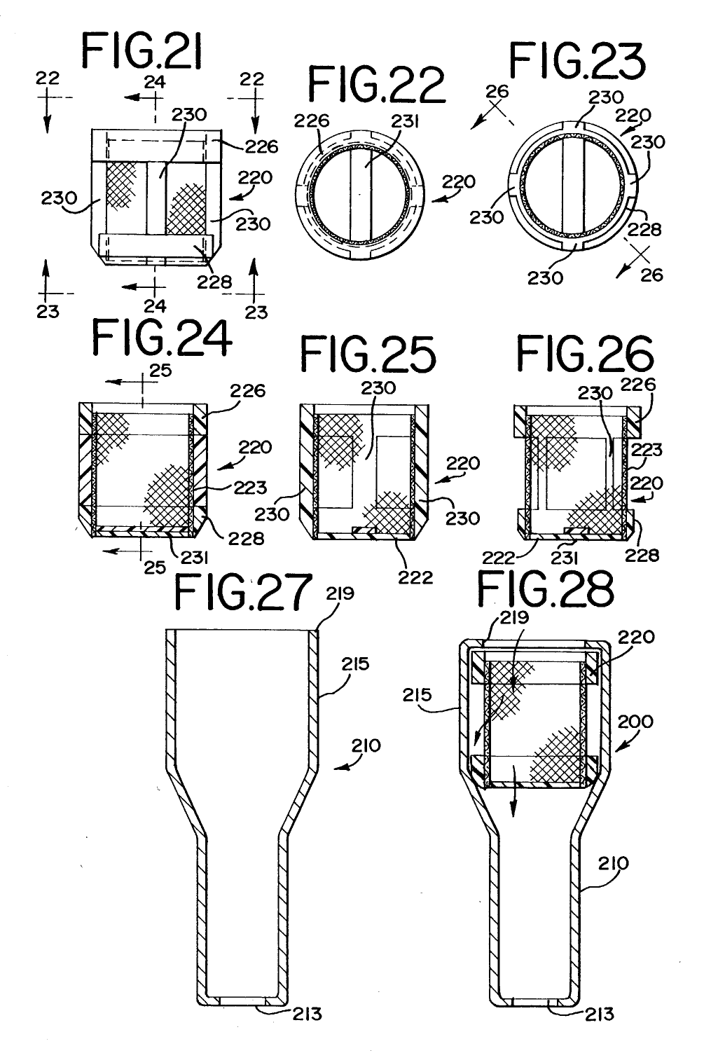

A third embodiment of a combined filter element and calibration tube 200 is shown in FIGS. 21-28. The calibration tube 210 has a main body portion 215 that is used to totally contain the filter element 220. The frame of filter element 220 comprises longitudinal ribs 230 and a lateral rib 231 at the base. The proximal end 226 is completely open. However, the lateral rib 231 works with the distal end frame section 228 to hold filtration media 222 across the bottom. Fuel flow is thus in through the center open top and out through filtration media forming cylindrical side wall 223 or bottom 222. Flow can then enter the internal volume of the calibration tube 210 and flow out an opening 213 in the bottom thereof (see FIG. 28; showing flow arrows). This filter thus has a generally radially outward filtration path, but also part of the filtration flow path is axially downward. Again, the proximal edge 219 of the housing is crimped over to secure the filter element 220 inside tube 210 (FIG. 28).

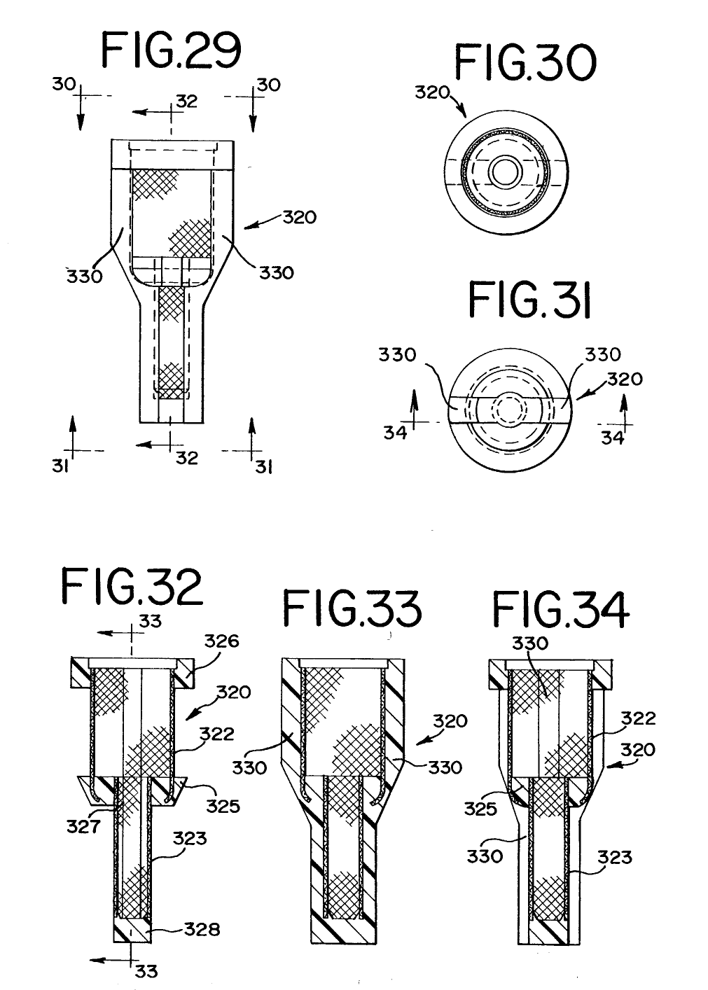

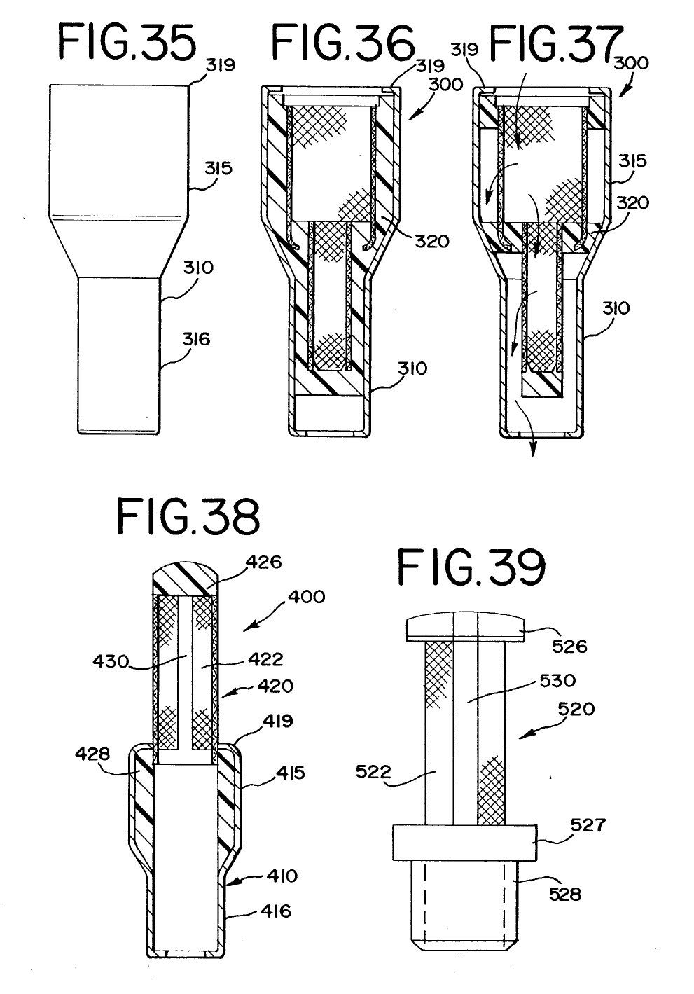

A fourth embodiment 300 is shown in FIGS. 29-37. The calibration tube 310 includes a main body portion 315 and a smaller diameter neck portion 316. However, in this embodiment, to increase the effective filtration surface area, the filter element 320 has two sections. The bottom section fits into neck portion 316 of tube 310, and the top section fits into main body portion 315. The filtration media is formed into two cylindrical portions, top portion 322 and bottom portion 323. The bottom of top portion 322 and the top of bottom portion 323 are captured by insert injection molding in the plastic used to form center member 325 of the frame of filtration element 320. Center section 325 has a hole 327 in its center so that fuel in the top cylinder can supply the bottom cylinder of filtration media 323. In this embodiment, flow through the filtration media is generally radially outward, as shown by flow across in FIG. 37.

The proximal end 326 and distal end 328, as well as center section 325, of the frame member are held in a spaced relationship by two ribs 330 that run the entire length of the filter element 320. Again, the proximal edge 319 of tube 310 is crimped over to hold the proximal end 326 of filter element 320. Inside the housing of calibration tube 310 (FIGS. 36 and 37), integrating the two pieces.

FIG. 38 shows a fifth integrated fuel element and calibration tube 400. The calibration tube 410 has a neck portion 416 and a larger main body portion 415. The fuel filter 420 has a distal end 428 that fits into the main body 415. The proximal end 419 of the tube 410 is crimped over to secure the two pieces together. Ribs 430 and a proximal end 426 of the frame hold the filtration media 422 into a generally cylindrical shape. The flow path is radially inward through the filtration media and the filter element 420 extends upstream of the calibration tube 410.

FIG. 39 shows a sixth filtration element 520 that can be used with a calibration tube such as tube 60 that has a shoulder section 67 at its top. In this embodiment, the flow is also radially inward through filtration media 522. The proximal end 526 and distal end 528 of the filter element 520 are connected by ribs 530. A shoulder 527 on distal end 528 is used to hold the filtration element 520 into a calibration tube so that the media 522 is exposed on the upstream side of the calibration tube.

By using the present invention, a single integrated fuel filter and calibration tube can be used to construct fuel injectors, simplifying assembly. The chance for particles being generated downstream of the filter by contact between the filter and the calibration tube is eliminated. The preferred embodiments are capable of mass manufacture using insert injection-molding techniques. Those embodiments that have outward-flow filtration are preferred because the media would not collapse if it became partially plugged.

It should be appreciated that the apparatus of the present invention is capable of being incorporated in the form of a variety of embodiments, only a few of which have been illustrated and described above. The invention may be embodied in other forms without departing from its spirit or essential characteristics. For example, instead of being made of stainless steel, the various calibration tubes could be made from bronze, brass or other materials, even polymers, if they could maintain a press-fit into the flow channel of the fuel injector. The frame of the filter element could be made of any material that would stand up to the fuel. Other filtration medias could be used. The described embodiments are to be considered in all respects only as illustrative and not restrictive, and the scope of the invention is, therefore, indicated by the appended claims rather than by the foregoing description. All changes that come within the meaning and range of equivalency of the claims are to be embraced within their scope.

1. An integrated fuel filter and calibration tube for a fuel injector comprising:
a) a filtration element comprising filtration media insert-molded into a thermoplastic frame member; and
b) a calibration tube rigidly attached to the filtration element, the calibration tube being sized so as to fit inside of a fuel injector flow channel.

2. The integrated fuel filter and calibration tube of claim 1 wherein the frame member comprises a proximal end, a distal end and at least one rib connecting the ends.

3. The integrated fuel filter and calibration tube of claim 1 wherein the proximal end comprises a fuel inlet opening.

4. The integrated fuel filter and calibration tube of claim 1 wherein the filtration media is held in a generally cylindrical shape by said frame member.

5. The integrated fuel filter and calibration tube of claim 4 wherein a flow path of fuel through the filtration media is generally radially outward.

6. The integrated fuel filter and calibration tube of claim 4 wherein a flow path of fuel through the filtration media is generally radially inward.

7. The integrated fuel filter and calibration tube of claim 1 wherein the filtration element is totally contained within the calibration tube.

8. The integrated fuel filter and calibration tube of claim 1 wherein the filtration element extends upstream from the calibration tube.

9. The integrated fuel filter and calibration tube of claim 1 wherein the filtration media comprises a woven nylon screen.

10. The integrated fuel filter and calibration tube of claim 1 wherein the frame member includes a shoulder used to secure the filtration element to the calibration tube.

11. An integrated fuel filter and calibration tube for a fuel injector comprising:
a) an elongated outside metal housing having a body with an inside diameter and an outside diameter, a neck at a distal end of the housing smaller in outside diameter than the outside diameter of the body and a shoulder at a proximal end of the housing larger in inside diameter than the inside diameter of the body; and
b) an injection-molded filter element inside the housing, the filter element comprising filtration media insert-molded into a frame, the frame comprising a proximal end having an outside diameter in between the inside diameters of the housing shoulder and the housing body, a distal end and a plurality of rib members joining the proximal end to the distal end, the frame holding the filtration media in a generally cylindrical shape.

12. The integrated fuel filter and calibration tube of claim 1 wherein a proximal edge of the housing shoulder is crimped over to hold a proximal end of the filter element frame against a juncture of the housing between the body and the shoulder

13. The integrated fuel filter and calibration tube of claim 11 having an effective filtration surface area of at least 60 mm².

14. The integrated fuel filter and calibration tube of claim 11 wherein the housing is made of stainless steel.

15. The integrated fuel filter and calibration tube of claim 11 wherein a proximal end of the frame comprises an inlet opening wherein fuel enters the filter element along its axial center and is filtered by flowing generally radially outward through the filtration media.

16. The integrated fuel filter and calibration tube of claim 11 wherein the frame comprises two ribs spaced at 180° from each other around the perimeter of the filtration media cylinder.

17. A combination of a fuel injector and an integrated fuel filter and calibration tube comprising:
a) a fuel injector having a fuel flow channel therethrough and a spring inside said flow channel; and
b) an integrated fuel filter and calibration tube inside said flow channel, said calibration tube contacting said spring, said fuel filter comprising a thermoplastic frame attached to said calibration tube, the frame having a proximal end, a distal end and at least one rib connecting the ends, the frame supporting filtration media to provide filtration of all fuel flowing through the fuel flow channel.

18. The combination of claim 17 wherein the flow channel has an upper portion with a first internal diameter and a lower portion with a second internal diameter smaller than the first internal diameter and the calibration tube has a shoulder on its proximal end press fit into the upper portion of the fuel flow channel.

19. The combination of claim 17 wherein the filter is totally contained within the calibration tube and has an effective filtration surface area of at least 60 mm².

20. The combination of claim 17 wherein the frame member includes a shoulder and an inlet opening at its proximal end, and the shoulder is held into a mating shoulder of the calibration tube by roll crimping the proximal edge of the calibration tube over the frame member shoulder.
